(19) United States
(12) Patent Application Publication
(10) Pub. No.: US 2002/0085108 A1
(43) Pub. Date: Jul. 4, 2002

(54) Reduced complexity interconnect for two dimensional multislice detectors

(76) Inventor: David M. Hoffman, New Berlin, WI (US)

Correspondence Address: John S. Beulick, Armstrong Teasdale LLP, Suite 2600, One Metropolitan Square, St. Louis, MO, 63102-2740, US

(21) Appl. No.: 09/751,891

(22) Filed: Dec. 29, 2000

(51) Int. Cl. H04N 3/14; H04N 5/335

(52) U.S. Cl. 348/302

(57) ABSTRACT

An enhanced CT detector module design utilizing a simplified FET mode option that effectively sums selected detector cells in X, allowing a coupling of scan slices in Z with the same or less number of DAS channels. In an embodiment of this invention wherein some cells float (i.e. they are left open) their collected charge will automatically re-distribute itself among the neighboring cells. This embodiment will allow cell summing in the x direction with a much simpler interconnect scheme i.e. far fewer FET switches and simplified decoder. Ideally there can be no increased in the number of FET switches/detector pixel)

### BACKGROUND OF THE INVENTION

This invention relates generally to radiation detectors of the scintillating type, and more particularly to a computer tomograph (CT) detector module having a reduced complexity interconnect and to methods for preparing and using the same.

In at least one known computed tomography (CT) imaging system configuration, an x-ray source projects a fan-shaped beam which is collimated to lie within an X-Y plane of a Cartesian coordinate system and generally referred to as the “imaging plane”. The x-ray beam passes through the object being imaged, such as a patient. The beam, after being attenuated by the object impinges upon an array of radiation detectors. The intensity of the attenuated beam radiation received at the detector array is dependent upon the attenuation of the x-ray beam by the object. Each detector element of the array produces a separate electrical signal that is a measurement of the beam attenuation at the detector location. The attenuation measurements from all the detectors are acquired separately to produce a transmission profile.

In known third generation CT systems the x-ray source and the detector array are rotated with a gantry within the imaging plane and around the object to be imaged so that the angle at which the x-ray beam intersects the object constantly changes. A group of x-ray attenuation measurements, i.e., projection data, from the detector array at one gantry angle is referred to as a “view.” A “scan” of the object comprises a set of views made at different gantry angles, or view angles, during one revolution the x-ray source and detector. In an axial scan, the projection data is processed to construct an image that corresponds to a two dimensional slice taken through the object. One method of reconstructing an image from a set of projection data is referred to in the art as the filtered back projection technique. This process converts the attenuation measurements from a scan into integers called “CT numbers” or “Hounsfield units” which are used to control the brightness of a corresponding pixel in a cathode ray tube display.

At least one known detector CT imaging system includes a plurality of detector modules, each having a scintillator array optically coupled to a semiconductor photodiode array that detects light output by the scintillator array. These known detector module assemblies require an adhesive bonding operation to assemble. The photodiode array and scintillator must be accurately aligned with an alignment system, using a plastic shim to set a gap between the photodiode and scintillator arrays. After alignment, the four corners of the assembly are tacked together with an adhesive to hold the alignment. The tack is cured, and the thin gap between the photodiode and scintillator arrays is filled by dipping the assembly into an optical epoxy adhesive, which wicks into the entire gap. The epoxy is cured, and the scintillator is thus epoxied to the diode array. Thus in a finished detector module the photodiode array and the scintillator array are separated by a solid, inflexible noncompliant. A detector module having epoxy that is still undergoing curing is not considered a finished detector module.

Accordingly, it would be desirable to provide an improved CT detector module design which effectively sums detector cells in X direction, while allows doubling of scan slices in Z, with the same or lesser number of DAS channels.

### BRIEF SUMMARY OF THE INVENTION

There is therefore provided, in one embodiment of the invention, an enhanced CT detector module utilizing a simplified FET that affectively sums detector cells in an X (direction), allowing a doubling of scan slices in Z direction with the same or a lesser number of DAS channels.

Among other advantages, this invention incorporates a much simpler FET/decoder chip. Fewer FETs are provided although the same number may be used in either embodiment providing a simpler decoder design.

Among other advantages, this invention permits summing detector cells in X direction, which allows a doubling of scan slices in Z direction with the same number of DAS channels but avoids many more FET switches, a much more complex decoder and many more FET decoder horizontal lines (X-direction) than current products. This invention also reduces overall FET /decoder size, cost and reliability.

In addition, this and other embodiments of the invention provide various combinations of additional advantages, including a simplified concept wherein some cells float (i.e. they are left open) and their collected charge will re-distribute itself among the neighboring cells. This embodiment allows cell summing in the x direction with a much simpler interconnect scheme i.e. far fewer FET switches and simplified decoder. Ideally there can be no increase in the number of FET switches/detector pixel.

### BRIEF DESCRIPTION OF THE DRAWINGS

FIG. 1 is a pictorial view of a CT imaging system.

FIG. 2 is a block schematic of the system illustrated in FIG. 1.

FIG. 3 is a perspective view of one embodiment of a CT system detector array of the present invention.

FIG. 4 is a perspective view of one of the detector module assemblies of the detector array shown in FIG. 3.

FIG. 5 is a top view of an 8×16 cell array in accordance with one embodiment of the invention.

FIG. 6 is a top view of an 8×16 cell array in accordance with one embodiment of the invention.

### DETAILED DESCRIPTION OF THE INVENTION

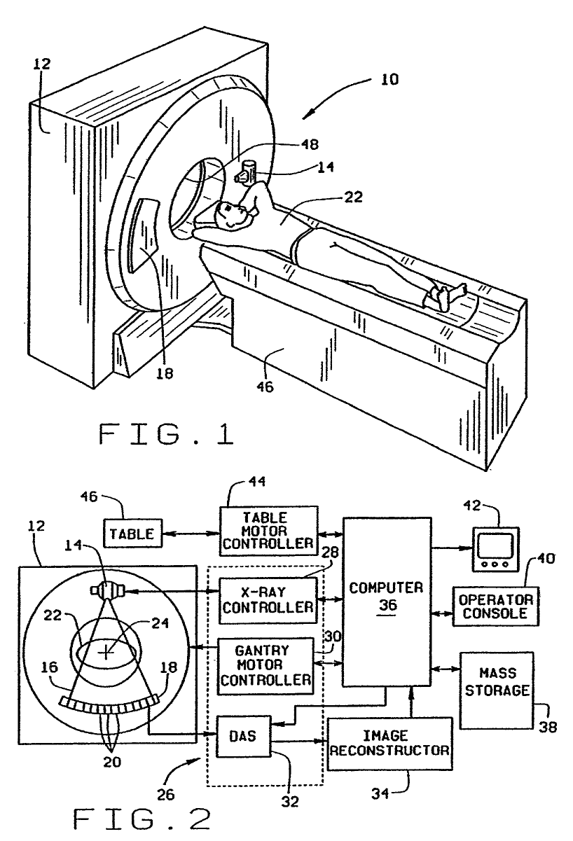

Referring to FIG. 1 and FIG. 2, a computed tomography (CT) imaging system 10 is shown as including a gantry 12 representative of a third generation CT scanner. Gantry 12 has an x-ray source that 14 that projects a beam of x-rays 16 toward a detector array 18 on opposite side of gantry 12. Detector array 18 is formed by detector elements 20 which together sense the projected x-rays that pass through an object 22, for example a medical patient. Each detector element 20 produces an electrical signal that represents the intensity of an impinging x-ray beam and hence the attenuation of the beam as it passes through patient 22. During a scan to acquire x-ray projection data, gantry 12 and the components mounted thereon rotate about a center of rotation 24. Detector array 18 may be fabricated in a single slice or multi-slice configuration. In a multi-slice configuration, detector array 18 has a plurality of rows of detector elements 20, only one of which is shown in FIG. 2.

Rotation of gantry 12 and the operation of x-ray source 14 are governed by a control mechanism 26 of CT system 10. Control mechanism 26 includes an x-ray controller 28 that provides power and timing signals to x-ray source 14 and a gantry motor controller 30 that controls the rotational speed and position of gantry 12. A data acquisition system (DAS) 32 in control mechanism 26 samples analog data from detector elements 20 and converts the data to digital signals for subsequent processing. An image reconstructor 34 receives sampled an digitized x-ray data from DAS 32 and performs high speed image reconstruction. The reconstructed image is applied as an input to a computer 36 which stores the image in a mass storage device 38.

Computer 36 also receives commands and scanning parameters from an operator via console 40 that has a keyboard. An associated cathode ray tube display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 in gantry 12. Particularly, table 46 moves portions of patient 22 through gantry opening 48.

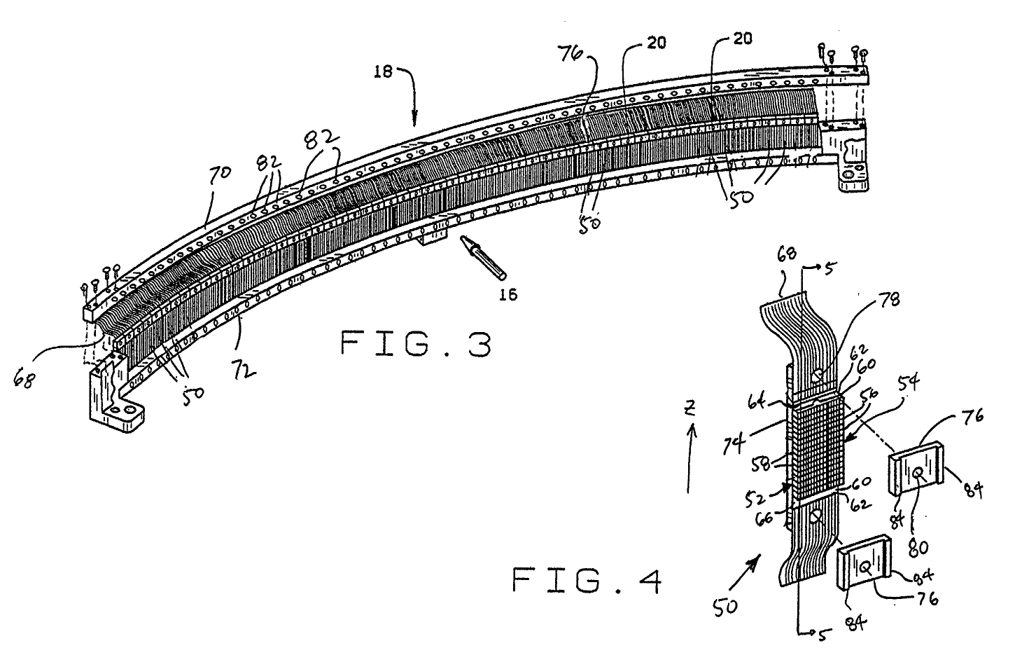

As shown in FIGS. 3 and 4, detector array 18 includes a plurality of detector module assemblies 50 (also referred to as detector modules), each module comprising an array of detector elements 20. Each detector module 50 includes a high-density photosensor array 52 and a multidimensional scintillator array 54 positioned above and adjacent to photosensor array 52. Particularly, scintillator array 54 includes a plurality 56, while photosensor array 52 includes photodiodes 58, a switch apparatus 60 and a decoder 62. A material such as a titanium dioxide-filled epoxy fills the small spaces between scintillator elements. Photodiodes 58 are individual photodiodes. In another embodiment, photodiodes 58 are deposited or formed on a substrate. Scintillator array 54, as known in the art, is positioned over or adjacent photodiodes 58. Photodiodes 58 are optically coupled to scintillator array 54 and have electrical output lines for transmitting signals representative of the light output by scintillator array 54. Each photodiode 58 produces a separate low level analog output signal that is a measurement of beam attenuation for a specific scintillator of scintillator array 54. Photodiode output lines (not shown in FIGS. 3 or 4) may, for example, be physically located on one side of module 20 or on a plurality of sides of module 20. In the embodiment illustrated in FIG. 4, photodiode outputs are located at opposing sides of the photodiode array.

In one embodiment, as shown in FIG. 3, detector array 18 includes fifty-seven detector modules 50. Each detector module 50 includes a photosensor array 52 and scintillator array 54, each having a detector element 20 array size of 16×16. As a result, array 18 is segmented into 16 rows and 912 columns (16×57 modules) allowing up to N=16 simultaneous slices of data to be collected along a z-axis with each rotation of gantry 12, where the z-axis is an axis of rotation of the gantry.

Switch apparatus 60 is a multidimensional semiconductor switch array. Switch apparatus 60 is coupled between photosensor array 52 and DAS 32. Switch apparatus 60, in one embodiment, includes two semiconductor switch arrays 64 and 66. Switch arrays 64 and 66 each include a plurality of field effect transistors (FETS) (not shown) arranged as a multidimensional array. Each FET includes an input electrically connected to one of the respective photodiode output lines, an output, and a control (not shown) arranged as a multidimensional array.

Each FET includes an input electrically connected to one of the respective photodiode output lines, an output, and a control (not shown). FET outputs and controls are connected to lines that are electrically connected to DAS 32 via a flexible electrical cable 68.

Particularly, about one-half of the photodiode output lines are electrically connected to each FET input line of switch 64 with the other one-half of photodiode output lines electrically connected to DAS 32 via a flexible electrical cable 68. Particularly about one-half of the photodiode output lines are electrically connected to each FET input line of switch 64 with the other one-half of photodiode output lines electrically connected to FET input lines of switch 66. Flexible electrical cable 68 is thus electrically coupled to photosensor array 52 and is attached, for example, by wire bonding.

Decoder 63 controls the operation of switch apparatus 60 to enable, disable, or combine photodiode 58 outputs depending upon a desired number of slices and slice resolution for each slide. Decoder 62 in one embodiment, is an FET controller as known in the art. Decoder 62 includes a plurality of output and control lines coupled to switch apparatus 60 and DAS 32. Particularly, the decoder outputs are electrically coupled to the switch apparatus control lines to enable switch apparatus 60 to transmit the proper data from the switch apparatus inputs to the switch apparatus outputs.

Utilizing decoder 62, specific FES within switch apparatus 60 are selectively enabled, disabled, or combined so that specific photodiode 58 outputs are electrically connected to CT system DAS 32. Decoder 62 enables switch apparatus 60 so that a selected number of rows of photosensor array 52 are connected to DAS 32, resulting in a selected number of slices of data being electrically connected to DAS 32 for processing.

As shown in FIG. 3, detector modules 50 are filled in a detector array 18 and secured in place by rails 70 and 72. FIG. 3 shows rail 72 secured in place, while rail 70 is positioned to be secured over electrical cable 68, over module substrate 74, flexible cable 68, and mounting bracket 76. Screws (not shown in FIGS. 3 or 4) are then threaded through holes 78 and 80 and into threaded holes 82 of rail 70 to secure modules 50 in place. Flanges 84 of mounting brackets 76 are held in place by compression against rails 70 and 72 (or by bonding, in one embodiment) and prevent detector modules 50 from “rocking”. Mounting brackets 76 also clamp flexible cable 68 against substrate 74, in one embodiment, flexible cable 68 is also adhesively bonded to substrate 74.

If desired, photosensor array can be adhesively bonded to the substrate. Flexible cable 68 is also electrically and mechanically bonded to photosensor array 52, for example, by wire bonding.

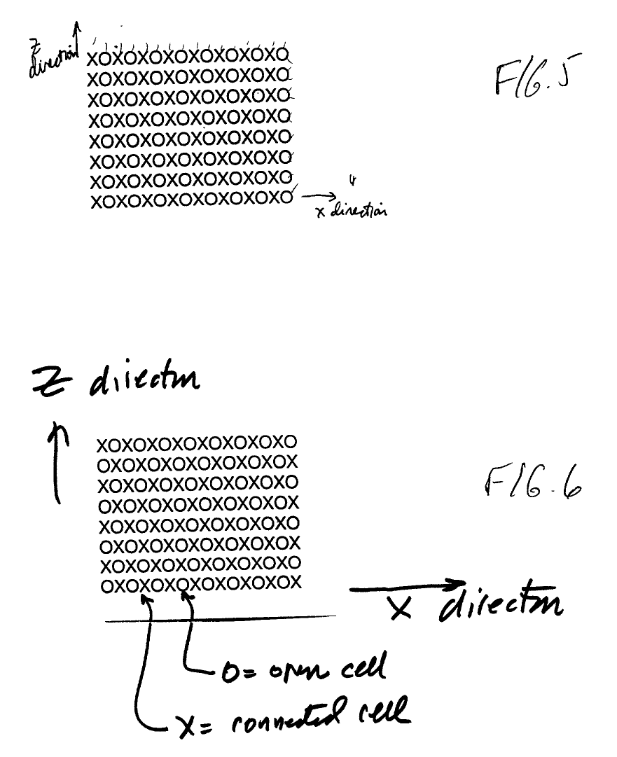

FIGS. 5 and 6 illustrate alternative embodiments of a photodiode wherein some cells float (i.e. they are left open) and their collected charge will automatically re-distribute itself among the adjacent connected cells. “x” cells are electrically connected. “o” cells are those cells shown floating open. (Only one half of a 16×16 diode array is shown in each Figure. This allows cell summing in the x direction with a much simpler interconnect scheme i.e. far fewer FET switches and a simplified decoder compared to known systems. In one embodiment there is no increase in the number of FET switches/detector pixel. There is also the capability to increase spatial resolution with the staggered cell design through using interpolation schemes between rows or slices.

In an alternative embodiment, the silicon in the open cell regions allows for a tailoring of the point response or charge collection response. Such tailoring could optionally be done by a radiologist operator of a CT using this invention to tailor the scan/data collection/sensitivity parameters.

In an embodiment, this invention concept could be coupled to a finer cell pitch in x direction, along with slice to slice interpolation perhaps with a tailored charge response and/or a tailored open cell silicon design to provide a scheme that is used at all times. This could potentially give more data slices with fewer DAS channels. It could potentially open the requirements n reflectors, scintillator cell sizes, etc.

In FIG. 5, one half of a 16×16 diode array comprising connectable cells, is shown with a z direction. An x direction is also shown. In this embodiment of an illustration of the invention a selected number of cells are combined in the x direction (the number being at least one cell less than the full number of such connectable cells). DAS is thus of constant bandwidth whereby the number of rows that can be processed are doubled.

In FIG. 6 one half of a 16×16 diode array, showing connectable cells, is shown with a z direction and an x direction. In this embodiment of an illustration of the invention, an alternative selected number of cells are combined in the x direction (the number being at least one cell less than the full number of such connectable cells).

In an embodiment of this invention, if cells on either side of a center cell are disconnected and only a center cell is connected, the charge would diffuse and be collected by the center electrode. Instead of using FETs to connect cells together, this embodiment uses disconnected cells and lets charge distribute itself to cells around the disconnected cells.

The design of the photodiode can be modified to change how charge is distributed, i.e. can tailor cells to redistribute e.g. mostly in rows or in a column in all eight adjacent cells, depending upon diffusion in p+ in cells left unconnected.

Typically, current collection in most systems is very crisp so that current cells collect charge in a crisply defined manner, with minimum cross talk to neighboring cells. In this concept rather than minimize cross talk, advantage is taken of it.

One embodiment herein which may be employed to take advantage of the cross talk is to modify the doping of a silicon chip. In this concept, the doping profile can be changed whereby the diode structure can be changed. In another modification, a bias can be applied in open pixel to drive the charge.

To preferentially distribute charge, the slopes of the diode are made assymetric, the side with the most p+ area, i.e. the most gradual slope will be the side to which the charge will preferentially migrate in such an embodiment.

If there is no change in the diode structure, (i.e. symmetric diode) that results in a symmetric charge redistribution, which is also an acceptable embodiment (maybe even preferred) so it is the easiest way to accomplished results of this invention.

If the p+ regions are moved (i.e. change their locations), a preferential redistribution occurs to cells that are closer to the disconnected regions.

The concentration of dopant during the doping of a silicon chip can be changed to give higher concentration in one direction than in another—this will move the charge in the direction of the highest concentration.

PIN type structure may be employed but embodiments of the invention can use other configurations (e.g. PN structures). The invention is utilized to disconnect some cells and collect the charges from adjacent cells to obtain combinations in x and z directions.

A further method of enhancing the summation counting of x cells in an embodiment of this invention involves the application of a bias on a pixel. One may apply a bias supply to forward bias then to drive charge to adjacent pixel. e.g. a connected channel 2 (corresponding to middle pixel) goes to DAS voltage on a diode and another diode would be forward biased i.e. positive voltage applied to p+, then the n+ region would be negative voltage. Biasing in the other direction could be done.

In one embodiment, the positive bias can be 0 to 10 volts for a positive bias, e.g. 2 volts, just enough to encourage the migration of charge. This will help to avoid conduction regions. This allows flexibility in the number of slices or x resolution with fixed number of DAS channels.

While the invention has been described in terms of various specific embodiments, those skilled in the art will recognize that the invention can be practiced with modification within the spirit and scope of the claims.

What is claimed is:

1. A method for summing outputs from a diode array in a multislice photodetector, having an array of scintillators optically coupled to an array of diodes, said method comprises summing a number of selectively connected cells in an x direction within the diode array wherein the number of selectively connected cells is less than the total number of cells capable of being connected.

2. A method in accordance with that of claim 1 wherein the selectively connected cells extend in the x direction.

3. A method in accordance with that of claim 1 wherein the selectively connected cells extend in the y direction.

4. A method in accordance with claim 2 wherein each connected cell is adjacent two unconnected cells.

5. A method in accordance with claim 2 wherein the diode is an assymetric diode.

6. A method in accordance with claim 2 wherein the diode is doped and has a doping profile.

7. A method in accordance with that of claim 6 wherein the doping profile includes sloped sides.

8. A method in accordance with that of claim 7 wherein the sloped sides have different slopes.

9. A method in accordance with that of claim 1 which comprises collecting charge from unconnected calls at adjacent connected cells.

10. A method in accordance with that of claim 9 wherein said step of collecting charge comprises the step of obtaining charge concentrations in at least one of the x direction and the z direction.

11. A method of modifying the charge profile in a photodetector system containing a DAS, and comprising an array of scintillators optically coupled to an array of photodiodes, wherein said method comprises selectively coupling cells in the charge regions of the photodiode with the DAS system.

12. A method in according with that of claim 11 wherein said selectively connected cells are in the x direction.

13. A method in accordance with that of claim 12 wherein said selectively connected cells extend in the y direction.

14. A method in accordance with claim 12 wherein said diode is an assymetric diode.

15. A method of modifying the charge profile in a photodetector system comprising an array of scintillators optically coupled to an array of photodiodes wherein said method comprises optically connecting an assymetric diode to said array of scintillators.

16. A method of modifying the charge profile in a photodetector system comprising an array of scintillators optically coupled to an array of photodiodes, wherein said method comrpises applying a charge bias to a pixel wherein the biased pixel is not optically coupled to the photodiode array.

17. A method in accordance with that of claim 16 wherein the biased pixel is biased to receive one of a negative charge and a positive charge.

18. A method in accordance with that of claim 17 wherein the biased pixel is biased to impart one of a positive charge and a negative charge to at least one adjacent pixel.

19. A multislice photodetector, having an array of scintillators optically coupled to an array of diodes, said detector having selectively connected cells in an x direction within the diode array wherein the number of selectively connected cells is less than the total number of cells capable of being connected.

20. A photodetector in accordance with that of claim 19 wherein the selectively connected cells extend in the x direction.

21. A photodetector in accordance with that of claim 19 wherein the selectively connected cells extend in the y direction

22. A photodetector in accordance with claim 19 wherein each connected cell is adjacent two unconnected cells.

23. A photodetector in accordance with claim 19 wherein the diode is an assymetric diode.

24. A photodetector in accordance with claim 19 wherein the diode is doped and has a doping profile.

25. A photodetector in accordance with that of claim 19 wherein the doping profile includes sloped sides.

26. A photodetector in accordance with that of claim 19 wherein the sloped sides have different slopes.

27. A photodetector in accordance with that of claim 19 wherein charge is collected from unconnected calls at adjacent connected cells.

28. A photodetector in accordance with that of claim 27 wherein said step of collecting charge comprises the step of otaining charge concentrations in at least one of the x direction and the z direction.

29. A photodetector in accordance with that of claim 19 wherein a charge bias is applied to a pixel wherein the biased pixel is not optically coupled to the photodiode array.
